(19) United States
(12) Patent Application Publication
(10) Pub. No.: US 2013/0132152 A1
(43) Pub. Date: May 23, 2013

(54) METHODS AND APPARATUS TO DETERMINE MEDIA IMPRESSIONS

(71) Applicants: Seema V. Srivastava, Sunnyvale, CA (US); Juliette Tabet, Menlo Park, CA (US)

(72) Inventors: Seema V. Srivastava, Sunnyvale, CA (US); Juliette Tabet, Menlo Park, CA (US)

(21) Appl. No.: 13/472,201

(22) Filed: May 15, 2012

Related U.S. Application Data
(60) Provisional application No. 61/509,009, filed on Jul. 18, 2011.

(51) Int. Cl. G06Q 30/02

(52) U.S. Cl. CPC G06Q 30/0201
USPC 705/7.29

(57) ABSTRACT

Example methods and apparatus to determine media impressions are disclosed. An example method includes determining a tail of panelists associated with monitoring information received from a panel, determining that the tail is the cause of volatility in the monitoring information, and adjusting monitoring information associated with the tail to reduce the volatility.

### RELATED APPLICATION

This patent claims priority to U.S. Provisional Patent Application Ser. No. 61/509,009, filed on Jul. 18, 2011, which is hereby incorporated herein by reference in its entirety.

### FIELD OF THE DISCLOSURE

The present disclosure relates generally to monitoring media and, more particularly, to methods and apparatus to determine media impressions.

### BACKGROUND

Audience measurement entities analyze audience engagement levels for media programming based on registered panel members. That is, an audience measurement entity enrolls people who consent to being monitored into a panel. The audience measurement entity then monitors those panel members to determine media (e.g., television programs or radio programs, movies, DVDs, advertisements, etc.) exposed to those panel members. Exposure of an expanded group (e.g., worldwide exposure, nationwide exposure, market-wide exposure, etc.) is then statically extrapolated from the panelist information.

For example, user access to Internet resources is often monitored through the use of panel software executing on panelist computers. The panel software may be installed by the user, may be installed by the audience measurement entity, may be installed in response to a user visiting a webpage, etc. The panel software transmits information about media (e.g., webpages) accessed by the panelist computers to a central facility for analysis.

### BRIEF DESCRIPTION OF THE DRAWINGS

FIG. 1 depicts an example system to collect and analyze panelist monitoring information.

FIG. 2 is a flow diagram representative of example machine readable instructions that may be executed to adjust panelist monitoring information to reduce volatility.

FIG. 3 is a flowchart representative of example machine readable instructions to determine if volatility in pageviews is caused by the tail of panelist monitoring information.

FIG. 4 is a flowchart representative of example machine readable instructions to adjust the tail of panelist monitoring information.

FIG. 5 is a flowchart representative of example machine readable instructions to determine a truncation threshold.

FIG. 6 is a flowchart representative of example machine readable instructions to adjust the tail of panelist monitoring information

FIG. 7 is an example processor system that can be used to execute the example instructions of FIGS. 2-6 to implement the example apparatus and systems of FIG. 1.

### DETAILED DESCRIPTION

Information collected from panelist computers access to media (e.g., webpage accesses known as pageviews) is often aggregated on a monthly basis for reporting. For example, a report may be generated indicating the number of pageviews for a given brand during the month of June). The monthly pageviews are often compared to determine volatility. This volatility in the number of pageviews may genuinely represent the number of visits to the webpage (e.g., due to seasonal behavior). For example, a webpage for a flower retailer will likely have a greater number of pageviews in months with holidays like Valentine's Day (February) and Mother's Day (May). Accordingly, it would be expected that a high volatility would be found by comparing April to May for the flower retailer's webpage.

In some instances, the pageview volatility (e.g., month to month volatility) may be caused by a small number of panelists that account for a large percentage of the total panelist pageviews. For example, a small number of panelists may visit a webpage more than the rest of the panelists combined. As used herein the relatively small number of panelists is known as the tail. For example, the tail may by the top 1% of panelists in terms of pageviews, the top 5% of panelists in terms of pageviews, the top 10% of panelists in terms of pageviews, or any other suitable percentage. If a member of the tail significantly changes their behavior, this change may cause a disproportionate change in the pageviews for the webpage.

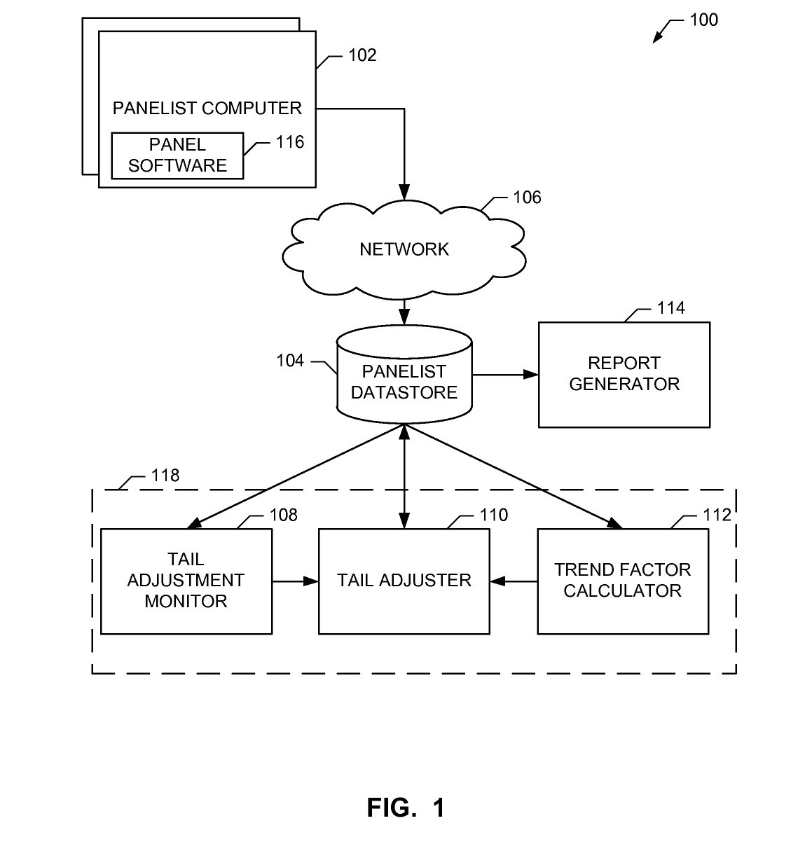

FIG. 1 is a block diagram of example system 100 for tracking and adjusting panelist data. The example system 100 includes one or more panelist computers 102 which transmit data to a panelist datastore 104 via a network 106. The system 100 also includes a tail adjustment monitor 108, a tail adjuster 110, a trend factor calculator 112, and a report generator 114.

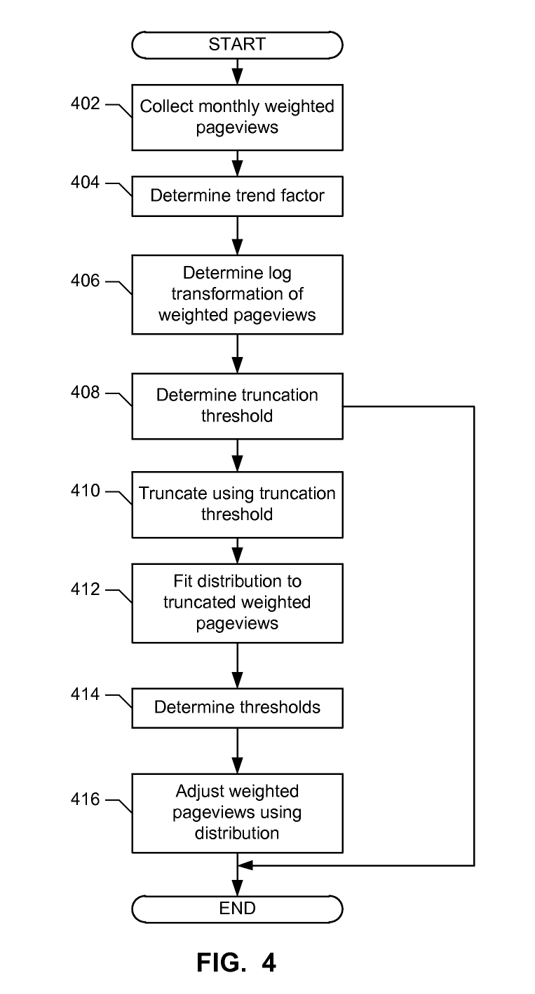

The panelist computers 102 of the illustrated example are computing devices that access and present webpages on the internet. The panelist computers may include personal computers, desktop computers, laptop computers, tablet computers, mobile computers, mobile phones, network enabled televisions, or any other suitable computing device. While two panelist computers 102 are illustrated in FIG. 4, any number of panelist computers may exist.

The example panelist computers 102 include panel software 116. The example panel software 116 monitors the usage of the panelist computers 102 and transmits information about the usage to the panelist datastore 104. The panel software 116 may also transmit identifying information about the panelist (e.g., a unique or semi-unique identifier, demographic information, etc.) to the panelist datastore 104. The panel software 116 may be any type of software and may be installed on the panelist computers 102 in any suitable manner. For example, the panel software 116 may be a standalone application, a plugin, a component of a webpage, a script, etc. The panel software 116 may be installed by a user of the panelist computers 102, may be installed by a manufacturer of the panelist computers 102, may be installed by or in response to visiting media such as a webpage, may be installed by an audience monitoring entity, etc. The panel software 116 may monitor any aspect of the panelist computers 102. For example, the panel software 116 may monitor access to a media such as a webpage, may monitor input devices such as keyboards and mice, may monitor information displayed on a monitor, may monitor sound output by speakers, may monitor processing performed by the panelist computers 102, etc.

The panelist datastore 104 of the illustrated example is a database that stores monitoring information received from the panelist computers 102. The panelist datastore 104 may be any type of data storage device and may use any type of data structure suitable for storing panelist information. While a single panelist datastore 104 is illustrated in FIG. 1, any number of panelist datastores may be employed. The panelist datastore 104 of the illustrated example is located at a central facility of an audience measurement entity. Alternatively, the panelist datastore 104 may be located at any other location. The panelist monitoring information stored by the panelist datastore 104 may be weighted based on the number of entities (e.g., people) that a panelist represents. For example, if there are three male panelists between the ages of 20 and 30 and a census indicates that there are 600 males between the ages of 20 and 30 in the relevant market, than each of the male panelists between the ages of 20 and 30 will be weighted to account for their representation of 200 (600÷3) people (e.g., each may be assigned a weight of 200 or any other representative weighting). Accordingly, the pageviews received from the weighted panelists are also weighted. Alternatively, weighting may not be used or any other weighting algorithm may be applied to the panelist monitoring information.

The network 106 of the illustrated example is the internet. However, any number or type of networks may be employed to communicatively couple the panelist computers 102 to the panelist datastore 104. For example, the network 106 may include one or more of a wireless network, a wired network, a wide area network, a local area network, a personal area network, etc.

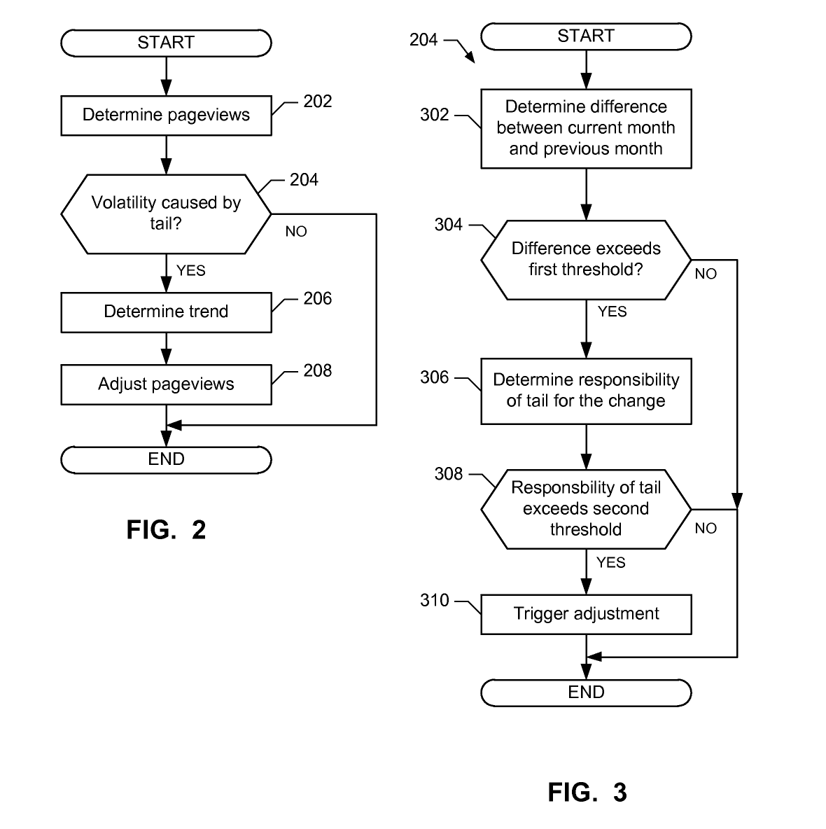

The tail adjustment monitor 108 of the illustrated example monitors monitoring information from panelist computers 102 in the panelist datastore 104 to determine if tail adjustment of the monitoring information is to be performed. For example, as described in further detail in conjunction with FIGS. 2 and 3, the tail adjustment monitor 108 may trigger adjustment of the tail for a monitored month of pageviews associated with a webpage when the adjustment monitor 108 determines that volatility between the monitored month and a previous month exceeds a threshold and is caused by the tail of the monitoring information. The tail adjustment monitor 108 may monitor the monitoring information in the panelist datastore 104 at any suitable interval. For example, the monitoring information may be analyzed at the end of each month to determine the volatility of the completed month compared with the preceding month. An example method that may be performed by the tail adjustment monitor 108 is described in conjunction with FIG. 3.

The tail adjuster 110 of the illustrated example adjusts the monitoring information in the panelist datastore 104 when triggered by the tail adjustment monitor 108. The tail adjuster 110 adjusts the monitoring information to reduce or eliminate the effects of volatility in the tail that is determined not to be genuine (e.g., volatility that is not representative of monitoring information as a whole). The tail adjuster 110 may adjust the monitoring information in the panelist datastore 104. Alternatively, the tail adjuster 110 may retrieve the monitoring information from the panelist datastore 104, adjust the monitoring information, and store the adjusted monitoring in the panelist datastore 104. Alternatively, any combination of retrieving and storing and modifying the data in the panelist datastore 104 may be employed. Example methods that may be performed by the tail adjuster 110 are described in conjunction with FIGS. 4-6.

As described above, some volatility in monitoring information from month to month is expected and may be caused by seasonal trends or other factors. The trend factor calculator 112 analyzes the monitoring information in the panelist datastore 104 to determine such trends and provides the information to the tail adjuster 110 for adjusting the monitoring information in a manner that includes the trends. An example trend factor calculated by comparing the pageviews of the current month to the pageviews of the previous 6 months may be computed as:

$${f}_{i , j} = \frac{\frac{{bwpvs}_{i , j}}{{c}_{i , j}}}{\frac{1}{6} \times {\sum }_{u = i - 6}^{u = i - 1} \frac{{bwpvs}_{u , j}}{{c}_{u , j}}}$$

where f_{i,j} is the trend factor for month i and brand j, bwpvs_{i,j} is the weighted pageviews for the bottom 99% of panelists for month i and brand j determined from the monitoring information in the panelist datastore 104, and c_{i,j} is the count of panelists who visited brand j during month i.

The tail adjustment monitor 108, the tail adjuster 110, and the trend factor calculator 112 may be separate components (e.g., separate devices) or may be implemented in a single component or apparatus (e.g., an adjustment manager 116). Additionally or alternatively, one or more of the tail adjustment monitor 108, tail adjuster 110, or the trend factor calculator 112 may be implemented with other components of a central facility such as, for example, the panelist datastore 104 and the report generator 114 described below.

The report generator 114 of the illustrated example generates reports of the monitoring information in the panelist datastore 104. For example, the report generator 114 may generate a report of monthly pageviews for a brand, annual pageviews for a brand, etc. The reports may be distributed to representatives of a brand or webpage, publications, industry groups, advertisers, or any other entity. The example report generator 114 generates reports after the tail adjustment monitor 108 has analyzed the monitoring information and any adjustment by the tail adjustment monitor 108 has been performed. The generation of reports of monitoring information is well known to those of ordinary skill and, thus, is not described in further detail herein.

While an example manner of implementing the system 100 is illustrated in FIG. 1, one or more of the elements, processes and/or devices illustrated in FIG. 1 may be combined, divided, re-arranged, omitted, eliminated and/or implemented in any other way. Further, the example the tail adjustment monitor 108, the example tail adjuster 110, the example trend factor calculator 112, the example report generator 114, the example adjustment monitor 116, and/or any other component of the example system 100 of FIG. 1 may be implemented by hardware, software, firmware and/or any combination of hardware, software and/or firmware. Thus, for example, any of the example the tail adjustment monitor 108, the example tail adjuster 110, the example trend factor calculator 112, the example report generator 114, the example adjustment manager 116, and/or any other component of the example system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example the tail adjustment monitor 108, the example tail adjuster 110, the example trend factor calculator 112, the example report generator 114, the example adjustment manager 116, and/or any other component of the example system 100 of FIG. 1 are hereby expressly defined to include a tangible computer readable medium such as a memory, DVD, CD, BluRay, etc. storing the software and/or firmware. Further still, the system 100 of FIG. 1 may include one or more elements, processes and/or devices in addition to, or instead of, those illustrated in FIG. 1, and/or may include more than one of any or all of the illustrated elements, processes and devices.

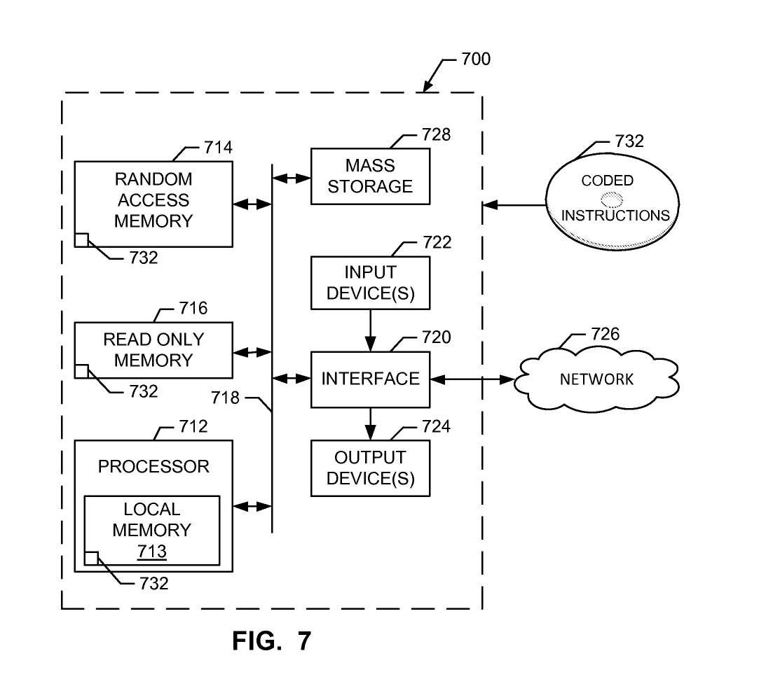

Flowcharts representative of example machine readable instructions for implementing the tail adjustment manager 116 of FIG. 1 are shown in FIGS. 2-6. In these examples, the machine readable instructions comprise a program(s) for execution by a processor such as the processor 712 shown in the example computer 700 discussed below in connection with FIG. 7. The program(s) may be embodied in software stored on a tangible computer readable medium such as a CD-ROM, a floppy disk, a hard drive, a digital versatile disk (DVD), a BluRay disk, or a memory associated with the processor 712, but the entire program and/or parts thereof could alternatively be executed by a device other than the processor 712 and/or embodied in firmware or dedicated hardware. Further, although the example program(s) is described with reference to the flowchart illustrated in FIGS. 2-6, many other methods of implementing the example tail adjustment manager 116 may alternatively be used. For example, the order of execution of the blocks may be changed, and/or some of the blocks described may be changed, eliminated, or combined.

As mentioned above, the example processes of FIGS. 2-6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 2-6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program of FIG. 2 begins with the tail adjustment monitor 116 determining pageviews (block 202). For example, the tail adjustment monitor 108 may analyze pageviews for an identified month, pageviews for multiple months, pageviews for a webpage of an identified brand, pageviews for multiple brands, etc. The example tail adjustment monitor 108 determines pageviews from the panelist database 104, which receives monitoring information including the pageview information from the panel software 116 executing on panelist computers 102.

The tail adjustment monitor 108 then determines if volatility in the pageviews is caused by a tail (e.g., the top 1% of panelists by pageview count) (block 204). For example, volatility may be caused by the tail when a small number of panelists (e.g., a single panelist) changes their behavior in a way that is not representative of the behavior of the whole or a larger set of panelists. For example, if a panelist in the tail for a brand were to go on vacation, their pageviews might drop drastically for the time they are on vacation and this drop is not representative of a general downward trend for the brand. An example program for determining if volatility is caused by the tail is described in conjunction with FIG. 3. When the tail adjustment monitor determines that volatility is not caused by the tail (or no volatility is present), the program of FIG. 2 is completed and not adjustment of the pageviews in the panelist datastore 104 is performed by the tail adjuster 110. For example, the report generator 114 may be instructed to generate a report of the pageviews.

When volatility in the pageviews is determined to be caused by the tail (block 204), the adjustment monitor 108 triggers the trend factor calculator 112 to determine a trend factor (block 206) and the tail adjuster 110 to adjust the pageviews (block 208). The trend factor calculator 112 may determine the trend factor by analyzing pageviews for previous time periods (e.g., previous months) to determine trends that are naturally occurring in the pageviews so that the trends can be accounted for by the tail adjuster 110. While the trend factor may not be included in all implementations, inclusion of the trend factor may reduce the changes of the tail adjuster 110 adjusting the data such that actual trends in the data are incorrectly removed. Example programs for implementing the tail adjuster 110 are described in conjunction with FIGS. 4-6.

After the pageviews are adjusted by the tail adjuster 110 the program of FIG. 2 terminates. For example, the adjusted pageview information may be stored in the panelist datastore 104 and/or the report generator 114 may be instructed to generate a report of the pageviews.

FIG. 3 is a flowchart representative of example machine readable instructions to implement block 204 of FIG. 2 to determine if volatility in pageviews is caused by the tail. The example program begins when the tail adjustment monitor 108 determines the difference between pageviews for a brand for the current time period (e.g., the current month) and pageviews for the brand for a previous time period (e.g., the previous month) (block 302). In this example, the difference is determined while examining pageviews attributed all panelists (i.e., panelists in the tail (e.g., the top 1% of panelists) and the remaining panelists (e.g., the bottom 99% of panelists)).

The tail adjustment monitor 108 then compares the difference to a first threshold to determine if difference exceeds the first threshold (block 304). The first threshold is indicative of a maximum amount of volatility that will be acceptable without triggering adjustment. The lower the first threshold the more aggressive the program will be in triggering adjustment. For example, the first threshold may be 10% indicating that adjustment will not be triggered if volatility is less than 10%. When the difference or volatility does not exceed the first threshold, the program of FIG. 3 terminates and adjustment is not triggered.

The pageviews may be normalized by the number of days in each month to ensure that pageviews in longer months do not appear as volatility (e.g., 31 days in January compared to 28 days in February). The calculation of volatility and comparison to the first threshold may be computed as:

$$\frac{\frac{{wpvs}_{i , j}}{{d}_{i}} - \frac{wp {\tilde{vs}}_{t - 1 , j}}{{d}_{t - 1}}}{\frac{wp {\tilde{vs}}_{t - 1 , j}}{{d}_{t - 1}}} > Threshold 1$$

where wpvs_{i,j} is weighted pageviews for month i and brand j determined from the panelist database 104, d, is the number of days in month i, [symbol] is the adjusted weighted pageviews for month i−1 and brand j that was previously adjusted by the adjustment manager 116 and stored in the panelist datastore 104, and Threshold 1 is the first threshold.

When the difference or volatility of the pageviews exceeds the first threshold (block 304), the tail adjustment monitor 108 determines the responsibility of the tail for the volatility (block 306). The tail adjustment monitor 108 determines if the responsibility of the tail for the volatility exceeds a second threshold (block 308). When the responsibility of the tail for the volatility does not exceed the second threshold the program of FIG. 3 terminates and adjustment is not performed. In other words, the volatility is determined to be present in the pageviews as a whole and, thus, adjustment of the tail is not triggered.

The determination of the contribution of the tail to the volatility and comparison to the second threshold may be determined as:

$$\frac{\frac{{twpvs}_{i , j}}{{d}_{i}} - \frac{twp {\tilde{vs}}_{t - 1 , j}}{{d}_{t - 1}}}{\frac{{wpvs}_{i , j}}{{d}_{i}} - \frac{wp {\tilde{vs}}_{t - 1 , j}}{{d}_{t - 1}}} > Threshold 2$$

where twpvs_{i,j} is the weighted pageviews for the tail of panelists (e.g., the top 1% of panelists by pageview) for month i and brand j determined from the monitoring information in the panelist datastore 104, dᵢ is the number of days in month i, [symbol] is the adjusted weighted pageviews for the tail for month i−1 and brand j that was previously adjusted by the adjustment manager 116 and stored in the panelist datastore 104, wpvs_{i,j} is weighted pageviews for month i and brand j determined from the panelist database 104, [symbol] is the adjusted weighted pageviews for month i−1 and brand j that was previously adjusted by the adjustment manager 116 and stored in the panelist datastore 104, and Threshold 2 is the second threshold.

The second threshold will control how aggressively the tail adjustment monitor 108 will trigger adjustment for volatility caused by the tail. The amount of volatility naturally caused by the tail may vary from brand to brand. For example, the tail for a first brand may typically account for 40% of month over month change while the tail for a second brand may typically account for 20% of month over month change. Accordingly, the second threshold of the illustrated example is determined based a historical view of the brand to be analyzed. In particular, the second threshold of the illustrated example is determined based on an average of the tail contribution to overall weighted pageviews for the past 6 months for the brand with a maximum second threshold of 60%:

$$Threshold 2 = Min ( 60 \% , {p}_{i , j} + 20 \% )$$

$$where$$

$${p}_{i , j} = \frac{1}{6} \times {\sum }_{u = i - 6}^{u = i - 1} \frac{tw {\tilde{pvs}}_{u , j}}{w {\tilde{pvs}}_{u , j}}$$

where [symbol] is the adjusted weighted pageviews for the tail for month i and brand j that was previously adjusted by the adjustment manager 116 and stored in the panelist datastore 104 and [symbol] is the adjusted weighted pageviews for month i and brand j that was previously adjusted by the adjustment manager 116 and stored in the panelist datastore 104.

When the tail adjustment monitor 108 determines that the responsibility of the tail for volatility of the pageviews exceeds the second threshold (block 308), the tail adjustment monitor 108 triggers adjustment by the tail adjuster 110 (block 310). The program of FIG. 3 then terminates. For example, control may return to block 206 of FIG. 2.

FIG. 4 is a flowchart representative of example machine readable instructions to implement blocks 206 and 208 of FIG. 2 to adjust the tail of pageviews. The program of FIG. 4 may be triggered by the tail adjustment monitor 108. The program of FIG. 4 begins when the tail adjuster 110 and the trend factor calculator 112 collect monthly weighted pageviews from the panelist datastore 104 (block 402). The pageview information may be collected for the time period to be analyzed and previous time periods (e.g., the current month and the prior six months. The trend factor calculator 112 then determines a trend factor for the brand to be analyzed (block 404). The trend factor may be determined as described in conjunction with FIG. 2. Alternatively, the trend factor may have been previously calculated and stored by the trend factor calculator 112 and/or the tail adjuster 110.

The example tail adjuster 110 then determines a logarithm transformation of the weighted pageviews (block 406). The logarithm is applied in the illustrated example to reduce the extent of the tail because the tail can have a very large number of pageviews relative to the rest of the panelists (e.g., the 99^{th} percentile of pageviews may be 157,328 while the tail includes data points as high as 9 million pageviews). The tail adjuster 110 then determines a truncation threshold (block 408).

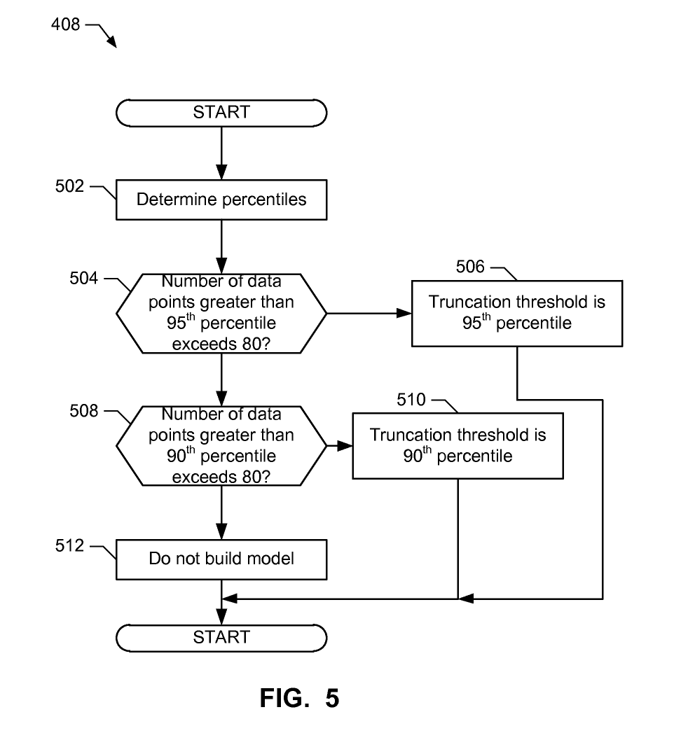

An example program for determining the truncation threshold is illustrated in FIG. 5. According to the illustrated example, the truncation threshold is determined where the count of data points of the logarithm of pageviews greater than the truncation threshold exceeds 80. The program begins by determining average empirical percentiles for the log(wpvs_{i,j}) (block 502). For example, the average empirical 90^{th} percentile (Q₉₀), the average empirical 95^{th} percentile (Q₉₅), and the average empirical 99^{th} percentile (Q₉₉) may be determined. The number of data points of log(wpvs_{i,j}) greater than the 95^{th} percentile is then compared to a threshold (e.g., 80) (block 504). When the number of data points exceeds the threshold, the 95^{th} percentile (e.g., represented by Q₉₅) is selected (block 506). When the number of data points is less than 80, The number of data points of log(wpvs_{i,j}) greater than the 90^{th} percentile is then compared to a threshold (e.g., 80) (block 508). When the number of data points exceeds the threshold, the 90^{th} percentile (e.g., represented by Q₉₀) is selected (block 510). If neither threshold meets the 80 data point threshold, according to the illustrated example, no distribution model is built for the data and the adjustment process is terminated (block 512). In other examples, the 80 data point threshold may be changed based on, for example, the total number of data points (e.g., a larger data point threshold may be employed with a larger set of panelists).

Returning to FIG. 4, after the truncation threshold is determined (block 408), tail adjuster 110 truncates the logarithm of pageviews at the truncation threshold (e.g., 90^{th} percentile, 95^{th} percentile, etc.). The data remaining represents the tail of panelists. Next the tail adjuster 110 fits a distribution to the truncated data (block 410). For example, according to the illustrated example a Weibull distribution is fitted to the data and the estimated parameters of the distribution are determined. For example, a Weibull distribution fitted to data truncated at the 95^{th} percentile may be defined by:

$${W}_{95} = σ \times {ln ( \frac{1}{1 - 0.95} )}^{\frac{1}{c}}$$

where σ is the scale of the distribution and c is the shape of the distribution. A distribution for the 99^{th} percentile may also be fit to the data. An example 99^{th} percentile Weibull distribution is defined as:

$${W}_{99} = σ \times {ln ( \frac{1}{1 - 0.99} )}^{\frac{1}{c}}$$

where σ is the scale of the distribution and c is the shape of the distribution. Any other suitable distribution may be used based on the distribution of the data such as, for example, a Burr distribution, an exponential distribution, a Pareto distribution, a Generalized Pareto Distribution, or any other type of parametric distribution, etc.

Using the fitted distributions, the tail adjuster 110 determines two thresholds (block 414). A first threshold is determined for W₉₅ as:

T₉₅=10^{U+W}^{₉₅}

where U is the truncation threshold determined in block 408. A second threshold is determined for W₉₉ as:

T₉₉=10^{U+W}^{₉₉}.

Next, the tail adjuster 110 determines an expected value for a panelist in the tail and adjusts the pageviews using the thresholds and the determined distributions (block 416). The expected value may be determined from the distribution data as:

$$EV = {10}^{U + \frac{1}{1 - F ( {Q}_{99} - U )} {\int }_{Q 99 - U}^{∞} xf ( x ) d x}$$

where EV is the expected value, U is the truncation threshold determined in block 408, F(x) is the cumulative density function from the fitted distribution, f(x) is the fitted probability density function from the fitted distribution. If the tail volatility is due to the tail being greater than expected, the tail is adjusted downward by capping the weighted pageviews in the tail at one of the thresholds estimated above. The threshold may be selected based on the threshold that results in the least volatility as compared with the previous month's adjusted fail. For example, the adjustment may be performed according to:

$$If$$

$$A B S ( \frac{tw {\tilde{pvs}}_{t - 1 , J}}{{d}_{i - 1}} - \frac{{\sum }_{k ε tail} min ( {wpvs}_{i , j , k} , {f}_{i , j} \times {T}_{95} )}{{d}_{i}} ) > A B S ( \frac{tw \tilde{{pvs}_{t - 1 , J}}}{{d}_{i - 1}} - \frac{{\sum }_{k ε tail} min ( {wpvs}_{i , j , k} , {f}_{i , j} \times {T}_{99} )}{{d}_{i}} )$$

$$Then$$

$$w {\tilde{pvs}}_{t , J , k} = min ( {wpvs}_{i , j , k} , {f}_{i , j} \times {T}_{99} )$$

$$Else$$

$$w {\tilde{pvs}}_{t , J , k} = min ( {wpvs}_{i , j , k} , {f}_{i , j} \times {T}_{95} )$$

where wpvs_{i,j,k} is the weighted pageviews for month i, brand j and panelist k and [symbol] is the adjusted weighted pageviews for month i, brand j and panelist k.

Alternatively, if the tail volatility is due to the tail being less than expected, the tail is adjusted upward to the expected value based on the trend factor. For example, the adjustment may be performed according to:

if twpvs_{i,j}<f_{i,j}×EV_{i,j}×0.01×C_{i,j}

then [symbol] =f_{i,j}×EV_{i,j}

else [symbol] =wpvs_{i,j,k}

After the adjustments are performed, the program of FIG. 4 terminates. Alternatively, the program may process a next month of pageview data, a next brand, etc.

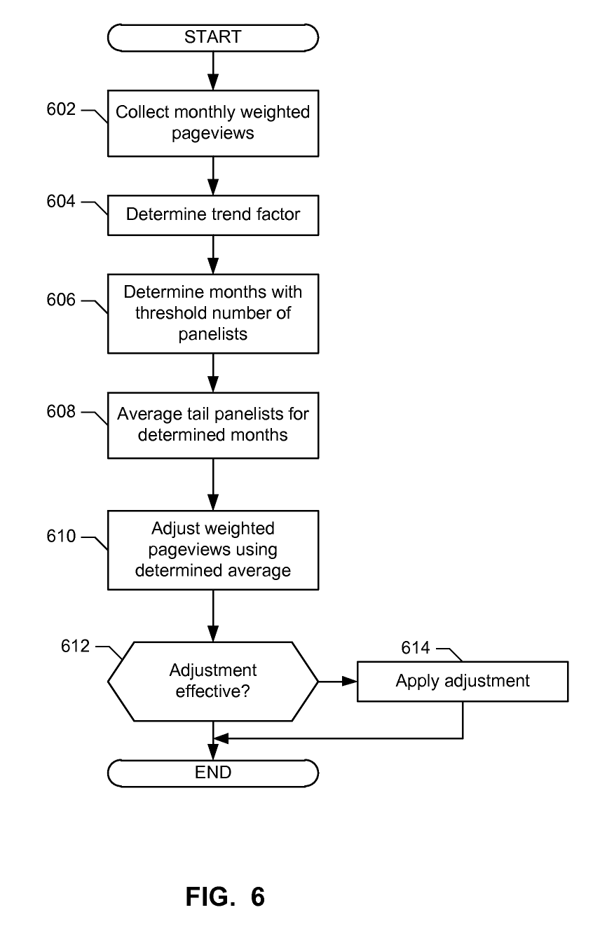

FIG. 6 is a flowchart representative of example machine readable instructions to implement blocks 206 and 208 of FIG. 2 to adjust the tail of pageviews. For example, the program of FIG. 6 may be performed instead of the program of FIG. 4. The program of FIG. 6 may be triggered by the tail adjustment monitor 108. The program of FIG. 6 begins when the tail adjuster 110 and the trend factor calculator 112 collect monthly weighted pageviews from the panelist datastore 104 (block 602). The pageview information may be collected for the time period to be analyzed and previous time periods (e.g., the current month and the prior six months. The trend factor calculator 112 then determines a trend factor for the brand to be analyzed (block 604). The trend factor may be determined as described in conjunction with FIG. 2. Alternatively, the trend factor may have been previously calculated and stored by the trend factor calculator 112 and/or the tail adjuster 110.

The example tail adjuster 110 then determines the months preceding the month under analysis that include more than a threshold number of panelists (block 606). For example, the threshold according to the illustrated example is 200. Alternatively, a different threshold may be selected based on the relative size of a panel where a higher threshold is selected for larger panels. The tail adjuster 110 averages the pageviews of the panelists in the tail for the months that meet the threshold (block 608). For example, the average may be calculated as:

$${EV}_{i , j} = \frac{1}{k} \times {\sum }_{u ∈ K , u \geq i - 6 , u \leq i - 1} \frac{tw {\tilde{pvs}}_{u , j}}{0.01 \times {C}_{u , j}}$$

where EV_{i,j} is the calculated expected value for month i and brand j, K is a list of the indices of the months in the past 6 months for which the number of panelists exceeds the threshold (e.g., 200), k is the number of months for which the number of panelists exceeds the threshold, [symbol] is the adjusted weight pageviews of the tail for month i, brand j, and C_{i,j} is count of raw panelists who visited brand j during month i.

The tail adjuster 110 then adjusts the weighted pageviews using the calculated expected value (block 610). If the tail volatility is due to the tail being greater than expected, the tail is adjusted downward by the expected value. For example, the adjustment may be performed as:

if twpvs_{i,j}>f_{i,j}×EV_{i,j}×0.01×C_{i,j}

then [symbol] =f_{i,j}×EV_{i,j}

else [symbol] =wpvs_{i,j,k}

where wpvs_{i,j,k} is the weighted pageviews for month i, brand j and panelist k.

If the tail volatility is due to the tail being less than expected, the tail is adjusted upward by the expected value

if twpvs_{i,j}<f_{i,j}×EV_{i,j}×0.01×C_{i,j}

then [symbol] =f_{i,j}×EV_{i,j}

else [symbol] =wpvs_{i,j,k}

where wpvs_{i,j,k} is the weighted pageviews for month i, brand j and panelist k.

After the adjustment is performed (block 610), the tail adjuster 110 determines if the adjustment was effective in adjusting the tail (block 612). For example, if the pageviews are to be adjusted upward, the tail adjuster 110 determines if the adjustment brings the weighted pageviews up for the aggregate tail. If the adjustment is effective, the adjustment is applied or committed (block 614). For example, the adjusted pageviews may be computed but not saved to the panelist datastore 104 until after the determination that the adjustment was effective. If the adjustment is not effective, the adjustment is not applied and the program of FIG. 6 terminates.

FIG. 7 is a block diagram of an example computer 700 capable of executing the instructions of FIGS. 2-6 to implement the system of FIG. 1 and/or any component thereof. The computer 700 can be, for example, a server, a personal computer, a mobile phone (e.g., a cell phone), a personal digital assistant (PDA), an Internet appliance, a DVD player, a CD player, a digital video recorder, a BluRay player, a gaming counsel, a personal video recorder, a set top box, or any other type of computing device.

The system 700 of the instant example includes a processor 712. For example, the processor 712 can be implemented by one or more microprocessors or controllers from any desired family or manufacturer.

The processor 712 is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The computer 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer, etc.). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The computer 700 also includes one or more mass storage devices 728 for storing software and data. Examples of such mass storage devices 728 include floppy disk drives, hard drive disks, compact disk drives and digital versatile disk (DVD) drives. The mass storage device 728 may implement the panelist datastore 104.

The coded instructions of FIGS. 2-6 may be stored in the mass storage device 728, in the volatile memory 714, in the non-volatile memory 716, and/or on a removable storage medium such as a CD or DVD

From the foregoing, it will appreciated that the above disclosed methods, apparatus and articles of manufacture facilitate the adjustment of panelist monitoring information that includes volatility. The adjustments may be performed when the volatility is due to a small number of panelists that account for a large number of records (e.g., pageviews) in the panelist monitoring information. Accordingly, more accurate panelist monitoring information may be determined and reported.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method comprising:
determining a tail of panelists associated with monitoring information received from a panel;
determining that the tail has caused volatility in the monitoring information; and
adjusting monitoring information associated with the tail to reduce the volatility.

2. A method as defined in claim 1, wherein determining the tail comprises:
determining a number of pageviews associated with each of the panelists; and
comparing the number of pageviews to determine a subset of panelists comprises at least the top ten percent of panelists by pageviews, wherein the tail comprises the subset of panelists.

3. A method as defined in claim 2, wherein the subset of panelists comprises the top one percent of panelists.

4. A method as defined in claim 1, wherein determining that the tail is the cause of volatility comprises:
determining a difference between a first number of pageviews for the tail for a first time period and a second number of pageviews for the tail for a second time period; and
determining that the tail has caused the volatility when the difference exceeds a threshold.

5. A method as defined in claim 4, further comprising:
determining a second difference between a third number of pageviews for the first time period and a fourth number of pageviews for the second time period; and
determining that the tail has caused the volatility when the second difference exceeds a second threshold.

6. A method as defined in claim 1, wherein adjusting the monitoring information associated with the tail comprises:
fitting a distribution to a portion of the monitoring information; and
adjusting the monitoring information associated with the tail based on the distribution.

7. A method as defined in claim 6, wherein adjusting the monitoring information comprises reducing a portion of the monitoring information associated with the tail to a threshold determined based on the threshold.

8. A method as defined in claim 1, wherein adjusting the monitoring information associated with the tail comprises:
determining an average of monitoring information for time periods preceding the time period to be adjusted; and
adjusting the monitoring information associated with the tail based on the average.

9. A method as defined in claim 8, wherein the time periods preceding the time period to be adjusted are selected based on a determination that a number of panelists during the time periods exceeds a threshold.

10. A method as defined in claim 1, wherein the monitoring information comprises pageviews.

11. An apparatus comprising:
a tail adjustment monitor to determine a tail of panelists associated with monitoring information received from a panel and to determine that the tail has caused of volatility in the monitoring information; and
a tail adjuster to adjust monitoring information associated with the tail to reduce the volatility.

12. An apparatus as defined in claim 11, wherein the tail adjustment monitor is to determine the tail by:
determining a number of pageviews associated with each of the panelists; and
comparing the number of pageviews to determine a subset of panelists comprises at least the top ten percent of panelists by pageviews, wherein the tail comprises the subset of panelists.

13. An apparatus as defined in claim 12, wherein the subset of panelists comprises the top one percent of panelists.

14. An apparatus as defined in claim 11, wherein the tail adjustment monitor is to determine that the tail is the cause of volatility by:
determining a difference between a first number of pageviews for the tail for a first time period and a second number of pageviews for the tail for a second time period; and
determining that the tail has caused the volatility when the difference exceeds a threshold.

15. An apparatus as defined in claim 14, wherein the tail adjustment monitor is to:
determine a second difference between a third number of pageviews for the first time period and a fourth number of pageviews for the second time period; and
determine that the tail has caused the volatility when the second difference exceeds a second threshold.

16. An apparatus as defined in claim 11, wherein the tail adjuster is to adjust the monitoring information associated with the tail by:
fitting a distribution to a portion of the monitoring information; and
adjusting the monitoring information associated with the tail based on the distribution.

17. An apparatus as defined in claim 16, wherein the tail adjuster is to adjust the monitoring information by reducing a portion of the monitoring information associated with the tail to a threshold determined based on the threshold.

18. An apparatus as defined in claim 11, wherein the tail adjuster is to adjust the monitoring information associated with the tail by:
determining an average of monitoring information for time periods preceding the time period to be adjusted; and
adjusting the monitoring information associated with the tail based on the average.

19. An apparatus as defined in claim 18, wherein the time periods preceding the time period to be adjusted are selected based on a determination that a number of panelists during the time periods exceeds a threshold.

20. An apparatus as defined in claim 11, wherein the monitoring information comprises pageviews.

21. A tangible computer readable storage medium storing instructions that, when executed cause a machine to at least:
determine a tail of panelists associated with monitoring information received from a panel;
determine that the tail has caused of volatility in the monitoring information; and
adjust monitoring information associated with the tail to reduce the volatility.

22-30. (canceled)
